(19) United States
(12) Patent Application Publication
(10) Pub. No.: US 2010/0272191 A1
(43) Pub. Date: Oct. 28, 2010

(54) METHODS AND APPARATUS FOR DE-ARTIFACT FILTERING USING MULTI-LATTICE SPARSITY-BASED FILTERING

(76) Inventors: Camilo Chang Dorea, Brasilia (BR); Oscar Divorra Escoda, Barcelona (ES); Peng Yin, Plainsboro, NY (US)

Correspondence Address: Robert D. Shedd, Patent Operations;THOMSON Licensing LLC, P.O. Box 5312, Princeton, NJ, 08543-5312, US

(21) Appl. No.: 12/735,329

(22) PCT Filed: Jan. 12, 2009
(86) PCT No.: PCT/US2009/000171

§ 371 Date: Jul. 2, 2010

Related U.S. Application Data
(60) Provisional application No. 61/020,940, filed on Jan. 14, 2008.

(51) Int. Cl. H04N 7/26

(52) U.S. Cl. 375/240.29; 382/260; 375/E07.193

(57) ABSTRACT

Methods and apparatus are provided for de-artifact filtering using multi-lattice sparsity-based filtering. The apparatus includes a sparsity-based filter (600) for de-artifact filtering picture data for a picture. The picture data includes different sub-lattice samplings of the picture. Sparsity-based filtering thresholds for the filter are varied temporally.

### CROSS-REFERENCE TO RELATED APPLICATIONS

This application claims the benefit of U.S. Provisional Application Ser. No. 61/020,940 (Attorney Docket No. PU080005), filed 14 Jan. 2008, which is incorporated by reference herein in its entirety.

### TECHNICAL FIELD

The present principles relate generally to video encoding and decoding and, more particularly, to methods and apparatus for de-artifact filtering using multi-lattice sparsity-based filtering.

### BACKGROUND

Video coding standards typically employ block-based transforms (e.g., such as, but not limited to, discrete cosine transforms, also referred to as DCTs) and motion compensation to achieve compression efficiency. Coarse quantization of the transform coefficients and the use of different reference locations or different reference pictures by neighboring blocks in motion-compensated prediction can give rise to visually disturbing artifacts such as distortion around edges, textures or block discontinuities.

Filtering strategies are commonly applied in video coding to attenuate compression artifacts and enhance the quality of the decoded video signal. In the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (hereinafter the “MPEG-4 AVC Standard”), an adaptive deblocking filter is introduced to combat the artifacts arising along block boundaries as described with respect to a first prior art approach. More generally, de-artifacting approaches have been proposed to combat artifacts not only on block discontinuities but also around image singularities (e.g., edges and/or textures), wherever these may appear, as described with respect to a second prior art approach and a third prior art approach. However, in order to maximize performance and in accordance with the second prior art approach, de-artifacting filters must consider local encoding conditions imposed by the video coding procedure. For instance, within a single frame, the MPEG-4 AVC Standard offers various prediction modes (intra, inter, skip, and so forth) each of which is subject to distinct quantization noise statistics and corresponding filtering demands. Moreover, temporal signal variations and the changes in picture content through time may influence the statistics of quantization noise present in the picture.

Thus, with respect to the filtering strategies commonly applied in video coding to attenuate compression artifacts and enhance the quality of the decoded video signal, the applied filters can either be deployed in a post-processing step or they may be integrated into the loop of a hybrid video encoder/decoder. As a post-processing step, the filter acts outside of the coding loop (out-loop) and does not affect the reference frames. The decoder is thus free to employ post-processing steps as deemed necessary. On the other hand, when applied within the coding loop (in-loop), the filter can improve pictures which will subsequently be used as reference frames. Improved reference frames can, in turn, offer higher quality prediction for motion compensation allowing superior compression performance.

Within the MPEG-4 AVC Standard, an in-loop deblocking filter as described with respect to the first prior art approach has been adopted. The filter acts to attenuate artifacts arising along block boundaries. Such artifacts are caused by coarse quantization of the transform (e.g., DCT) coefficients as well as motion compensated prediction. By adaptively applying low-pass filters to the block edges, the deblocking filter can improve both subjective and objective video quality. The filter operates by performing an analysis of the samples around a block edge and adapts filtering strength to attenuate small intensity differences attributable to blocking artifacts while preserving the generally larger intensity differences pertaining to the actual image content. Several block coding modes and conditions also serve to indicate the strength with which the filters are applied. These include inter/intra prediction decisions, the presence of coded residuals and motion differences between adjacent blocks. Besides adaptability on the block-level, the deblocking filter is also adaptive at the slice-level and the sample-level. On the slice level, filtering strength can be adjusted to the individual characteristics of the video sequence. On the sample level, filtering can be turned off at each individual sample depending on sample value and quantizer-based thresholds.

The blocking artifacts removed by the MPEG-4 AVC Standard deblocking filter are not the only artifacts present in compressed video. Coarse quantization is also responsible for other artifacts such as ringing, edge distortion and/or texture corruption. The deblocking filter cannot reduce artifacts caused by quantization errors which appear inside a block. Moreover, the low-pass filtering techniques employed in deblocking assume a smooth image model and are not suited for processing image singularities such as edges or textures.

In order to overcome the limitations of MPEG-4 AVC Standard deblocking filter, a denoising type nonlinear in-loop filter has been recently proposed, for example such as that described with respect to the second prior art approach. This nonlinear denoising filter adapts to non-stationary image statistics exploiting a sparse image model using an over-complete set of linear transforms and a thresholding operation. The nonlinear denoising filter automatically becomes high-pass, or low-pass, or band-pass, and so forth, depending on the region the filter is operating on. The nonlinear denoising filter is broadly applicable, providing robust solutions for areas including image singularities.

The denoising in-loop filter described with respect to the second prior art approach uses a set of denoised estimates provided by an over-complete set of transforms. This implementation generates an over-complete set of transforms by using all possible translations Hᵢ of a given two-dimensional (2D) orthonormal transform H, such as wavelets or DCT. Thus, given an image I, a series of different transformed versions Yᵢ of the image I is created by applying the various transforms Hᵢ. Each transformed version Yᵢ is then subject to a denoising procedure, typically including a thresholding operation, producing the series of Y′ᵢ. The transformed and thresholded coefficients Y′ᵢ are then inverse transformed back into the spatial domain, giving rise to the denoised estimates I′ᵢ. In over-complete settings, it is expected that some of the denoised estimates will provide better performance than others and that the final filtered version I′ will benefit from a combination via averaging of such denoised estimates. The denoising filter described with respect to the second prior art approach proposes the weighted averaging of denoised estimates I′ᵢ where the weights are optimized to emphasize the best denoised estimates. Weighting approaches can be various and they may be dependent on the data to be filtered, on the transforms being used, and on statistical assumptions regarding noise. When using block transforms, the second prior art approach presents a practical weighing approach based on sparseness measurements of the decompositions provided by such transforms. Furthermore, the scheme described with respect to the second prior art approach accommodates temporally encoded frames by applying a mask function which excludes selected pixels from undergoing filtering and by locally determining filtering thresholds in accordance with encoding conditions and the codec quantization parameter (QP).

In spite of its broad applicability, the denoising filter of the second prior art approach presents three main limitations. First, the use of translated versions Hᵢ of a given orthonormal transform constrains the directions of analysis of the over-complete transform set exclusively to the vertical and horizontal components. This constraint on the directions of structural analysis can impair the proper filtering of signal structures which have orientations different from vertical or horizontal. Second, some transforms Hᵢ are similar or equal to the transforms used to code the residual signal in the video coding process. Transforms used in coding are often responsible for reducing the number of coefficients available for reconstruction. This reduction can alter the sparseness measurements used to compute the optimum weights for denoised estimate combination in the second prior art approach and permits the presence of artifacts after filtering. Third, in spite of mechanisms for accommodating temporally encoded frames (mask functions and spatially localized thresholds), threshold selection is not temporally adaptive to signal structure, coding models and/or quantization noise statistics.

The direction-adaptive de-artifact filter of the third prior art approach is a high-performance non-linear in-loop filter providing reduction of various artifacts types including blocking artifacts as well as artifacts arising within blocks or around image singularities. The filter is based on weighted combinations of denoised estimates provided by an over-complete set of transforms. However, unlike the denoising filter of the second prior art approach, the direction-adaptive de-artifact filter of the third prior art approach exploits different sub-lattice samplings of the picture to be filtered in order to extend the directions of analysis beyond vertical and horizontal components. Furthermore, the direction-adaptive de-artifacting filter excludes from the weighted combination the denoised estimates originating from transforms which are similar or closely aligned to the transforms used in coding residue.

Direction-adaptiveness of the filter is achieved by applying translations Hᵢ of the given transform H over different sub-samplings of the image. Oriented sub-sampling patterns can adapt the directions of decomposition of the transforms. For example, turning to FIG. 1, a decomposition of a rectangular grid into two complementary quincunx lattices is indicated generally by the reference numeral 100. The two complementary quincunx lattices are respectively represented by the set of black dots and the set of white dots. Any transform suitable for a rectangular grid may then be applied on the lattice sub-sampled signals, extending the directions of analysis beyond the vertical and horizontal. Denoised estimates Iᵢ may be obtained by following the transformation, thresholding, inverse transformation approach and re-arranging the results from the complementary sub-samplings back into the original lattice. As described with respect to the third prior art approach, multiple lattice processing is proposed whereby the original sampling grid is used in conjunction with the two quincunx sub-sampling lattices. Denoised estimates originating from each of the multiple lattices are then combined through a weighted combination. The weights of denoised estimates pertaining to transform decompositions of greater sparseness are attributed higher values. This comes from the assumption that the sparser decompositions include the lowest amount of noise.

Turning to FIG. 2, a direction-adaptive de-artifact filter is indicated generally by the reference numeral 200. The filter 200 corresponds to the third prior approach. It is to be noted that the denoise coefficients modules 212, 214, and 216 require knowledge of a filtering threshold.

An output of a downsample and sample rearrangement module 202 is connected in signal communication with an input of a forward transform module (with redundant set of transforms B) 208. An output of a downsample and sample rearrangement module 204 is connected in signal communication with an input of a forward transform module (with redundant set of transforms B) 210.

An output of a forward transform module (with redundant set of transforms A) 206 is connected in signal communication with a denoise coefficients module 212. An output of a forward transform module (with redundant set of transforms B) 208 is connected in signal communication with a denoise coefficients module 214. An output of a forward transform module (with redundant set of transforms B) 210 is connected in signal communication with a denoise coefficients module 216.

An output of denoise coefficients module 212 is connected in signal communication with an input of a computation of number of non-zero coefficients affecting each pixel module 226, and an input of an inverse transform module (with redundant set of transforms A) 218. An output of denoise coefficients module 214 is connected in signal communication with an input of a computation of number of non-zero coefficients affecting each pixel module 230, and an input of an inverse transform module (with redundant set of transforms B) 220. An output of denoise coefficients module 216 is connected in signal communication with an input of a computation of number of non-zero coefficients affecting each pixel module 232, and an input of an inverse transform module (with redundant set of transforms B) 222.

An output of the inverse transform module (with redundant set of transforms A) 218 is connected in signal communication with a first input of a combine module 236. An output of the inverse transform module (with redundant set of transforms B) 220 is connected in signal communication with a first input of an upsample, sample rearrangement and merge cosets module 224. An output of the inverse transform module (with redundant set of transforms B) 222 is connected in signal communication with a second input of an upsample, sample rearrangement and merge cosets module 224.

An output of the computation of number of non-zero coefficients affecting each pixel for each transform module 230 is connected in signal communication with a first input of an upsample, sample rearrangement and merge cosets module 228. An output of the computation of number of non-zero coefficients affecting each pixel for each transform module 232 is connected in signal communication with a second input of the upsample, sample rearrangement and merge cosets module 228.

An output of the upsample, sample rearrangement and merge cosets module 228 is connected in signal communication with a first input of a general combination weights computation module 234. An output of the computation of number of non-zero coefficients affecting each pixel 226 is connected in signal communication with a second input of a general combination weights computation module 234. An output of the general combination weights computation module 234 is connected in signal communication with a second input of the combine module 236.

An output of the upsample, sample rearrangement and merge cosets module 224 is connected in signal communication with a third input of a combine module 236.

An input of the forward transform module (with redundant set of transforms A) 206, an input of the downsample and sample rearrangement module 202, and an input of the downsample and sample rearrangement module 204 are each available as input of the filter 200, for receiving an input image. An output of the combine module 236 is available as an output of the filter, for providing an output image.

Turning to FIG. 3, a method for direction-adaptive de-artifact filtering is indicated generally by the reference numeral 300. The method 300 corresponds to the third prior approach. The method 300 includes a start block 305 that passes control to a function block 310. The function block 310 sets the shape and number of possible families of sub-lattice image decompositions, and passes control to a loop limit block 315. The loop limit block 315 begins a loop j over every family of (sub)-lattices, and passes control to a function block 320. The function block 320 downsamples ad splits an image into N sub-lattices according to the family of sub-lattices j (where the total number of sub-lattices depends on every family j), and passes control to a loop limit block 325. The loop limit block 325 begins a loop i for every sub-lattice (where the total amount depends on the family j), and passes control to a function block 330. The function block 330 re-arranges samples (e.g., from arrangement A(j,K) to B), and passes control to a function block 335. The function block 335 selects which transforms are allowed to be used for a given family of sub-lattices j, and passes control to a loop limit block 340. The loop limit block 340 begins a loop i over every allowed transform (selected depending on the sub-lattice family j, e.g., some translations may not be allowed for a given j), and passes control to a function block 345. The function block 345 performs a transform with transform matrix i, and passes control to a function block 350. The function block 350 de-noises coefficients, and passes control to a function block 355. The function block 355 performs an inverse transform with inverse transform matrix i, and passes control to a loop limit block 360. The loop limit block 360 ends the loop i, and passes control to a function block 365. The function block 365 re-arranges samples (e.g., from arrangement B to A(j,k)), and passes control to a loop limit block 370. The loop limit block 370 ends the loop k, and passes control to a function block 375. The function block 375 upsamples and merges sub-lattices according to the family of sub-lattices j, and passes control to a loop limit block 380. The loop limit block 380 ends the loop j, and passes control to a function block 385. The function block 385 combines (e.g., locally adaptive weighted sum of) the different inverse transformed versions of the denoised coefficient images, and passes control to an end block 390.

The direction-adaptive de-artifacting filter considers the use of the 4×4 DCT or the integer MPEG-4 AVC Standard transforms giving rise to a total of 16 possible translations of these transforms. When applied over an original sampling grid, several of the translated transforms may overlap or nearly overlap with the transforms used in residue coding. In this case, it may occur that both the quantization noise/artifact and the signal fall within the same sub-space of basis functions leading to an artificially large sparseness measure. In order to avoid these pitfalls, the third prior art approach proposes the exclusion of denoised estimates from transforms aligned or mostly aligned (for example those with 1 pixel of mis-alignment in at most one of the horizontal or vertical directions) to the transforms used in residue coding. The principle of the third prior art approach applies to other transforms as well, such as the 8×8 DCT or the integer 8×8 transform of the MPEG-4 AVC Standard.

In filtering approaches based on weighted combinations of denoised estimates, such as those disclosed in the second and third prior art approaches, the choice of a filtering threshold is of great importance. The applied threshold plays a crucial part in controlling the denoising capacity of the filter as well as in computing the averaging weights used in emphasizing the better denoising estimates. Inadequate threshold selection may result in over-smoothed reconstructed pictures or may allow the persistence of artifacts. In the de-artifacting framework of the third prior art approach, a common threshold is applied to all denoising of transform coefficients and sparseness measurements associated to weight computations. Within the block diagram of FIG. 2, these filtering thresholds are directly involved in the denoised coefficients modules 212, 214, and 216 and the computation of number of non-zero coefficients affecting each pixel modules 226, 230, and 232.

Direction-adaptive de-artifacting filter results for the third prior art approach demonstrate the efficacy of multi-lattice analysis, however, usage of a unique and uniform threshold value can restrict filtering potential. For example, the threshold value is dependent on signal characteristics and these may vary over space and time. Processing multiple video frames, even in intra encoding mode, should account for this, considering methods for threshold adaptability. Furthermore, threshold selection for temporally encoded content is not addressed by the third prior art approach. This scenario is of great interest and poses new challenges as various prediction modes (intra, inter, skip, and so forth) may co-exist within a single frame. Each of these modes presents unique quantization noise statistics and requires dedicated filtering strategies. In summary, neither the second nor third prior art approaches account for joint spatio-temporal variability of quantization noise statistics in the filtering process.

Turning to FIG. 4, a video encoder capable of performing video encoding in accordance with the MPEG-4 AVC standard is indicated generally by the reference numeral 400.

The video encoder 400 includes a frame ordering buffer 410 having an output in signal communication with a non-inverting input of a combiner 485. An output of the combiner 485 is connected in signal communication with a first input of a transformer and quantizer 425. An output of the transformer and quantizer 425 is connected in signal communication with a first input of an entropy coder 445 and a first input of an inverse transformer and inverse quantizer 450. An output of the entropy coder 445 is connected in signal communication with a first non-inverting input of a combiner 490. An output of the combiner 490 is connected in signal communication with a first input of an output buffer 435.

A first output of an encoder controller 405 is connected in signal communication with a second input of the frame ordering buffer 410, a second input of the inverse transformer and inverse quantizer 450, an input of a picture-type decision module 415, a first input of a macroblock-type (MB-type) decision module 420, a second input of an intra prediction module 460, a second input of a deblocking filter 465, a first input of a motion compensator 470, a first input of a motion estimator 475, and a second input of a reference picture buffer 480.

A second output of the encoder controller 405 is connected in signal communication with a first input of a Supplemental Enhancement Information (SEI) inserter 430, a second input of the transformer and quantizer 425, a second input of the entropy coder 445, a second input of the output buffer 435, and an input of the Sequence Parameter Set (SPS) and Picture Parameter Set (PPS) inserter 440.

An output of the SEI inserter 430 is connected in signal communication with a second non-inverting input of the combiner 490.

A first output of the picture-type decision module 415 is connected in signal communication with a third input of a frame ordering buffer 410. A second output of the picture-type decision module 415 is connected in signal communication with a second input of a macroblock-type decision module 420.

An output of the Sequence Parameter Set and Picture Parameter Set inserter 440 is connected in signal communication with a third non-inverting input of the combiner 490.

An output of the inverse quantizer and inverse transformer 450 is connected in signal communication with a first non-inverting input of a combiner 419. An output of the combiner 419 is connected in signal communication with a first input of the intra prediction module 460 and a first input of the deblocking filter 465. An output of the deblocking filter 465 is connected in signal communication with a first input of a reference picture buffer 480. An output of the reference picture buffer 480 is connected in signal communication with a second input of the motion estimator 475 and with a third input of the motion compensator 470. A first output of the motion estimator 475 is connected in signal communication with a second input of the motion compensator 470. A second output of the motion estimator 475 is connected in signal communication with a third input of the entropy coder 445.

An output of the motion compensator 470 is connected in signal communication with a first input of a switch 497. An output of the intra prediction module 460 is connected in signal communication with a second input of the switch 497. An output of the macroblock-type decision module 420 is connected in signal communication with a third input of the switch 497. The third input of the switch 497 determines whether or not the “data” input of the switch (as compared to the control input, i.e., the third input) is to be provided by the motion compensator 470 or the intra prediction module 460. The output of the switch 497 is connected in signal communication with a second non-inverting input of the combiner 419 and with an inverting input of the combiner 485.

A first input of the frame ordering buffer 410 and an input of the encoder controller 405 are available as input of the encoder 400, for receiving an input picture. Moreover, a second input of the Supplemental Enhancement Information (SEI) inserter 430 is available as an input of the encoder 400, for receiving metadata. An output of the output buffer 435 is available as an output of the encoder 400, for outputting a bitstream.

Turning to FIG. 5, a video decoder capable of performing video decoding in accordance with the MPEG-4 AVC standard is indicated generally by the reference numeral 500.

The video decoder 500 includes an input buffer 510 having an output connected in signal communication with a first input of the entropy decoder 545. A first output of the entropy decoder 545 is connected in signal communication with a first input of an inverse transformer and inverse quantizer 550. An output of the inverse transformer and inverse quantizer 550 is connected in signal communication with a second non-inverting input of a combiner 525. An output of the combiner 525 is connected in signal communication with a second input of a deblocking filter 565 and a first input of an intra prediction module 560. A second output of the deblocking filter 565 is connected in signal communication with a first input of a reference picture buffer 580. An output of the reference picture buffer 580 is connected in signal communication with a second input of a motion compensator 570.

A second output of the entropy decoder 545 is connected in signal communication with a third input of the motion compensator 570 and a first input of the deblocking filter 565. A third output of the entropy decoder 545 is connected in signal communication with an input of a decoder controller 505. A first output of the decoder controller 505 is connected in signal communication with a second input of the entropy decoder 545. A second output of the decoder controller 505 is connected in signal communication with a second input of the inverse transformer and inverse quantizer 550. A third output of the decoder controller 505 is connected in signal communication with a third input of the deblocking filter 565. A fourth output of the decoder controller 505 is connected in signal communication with a second input of the intra prediction module 560, with a first input of the motion compensator 570, and with a second input of the reference picture buffer 580.

An output of the motion compensator 570 is connected in signal communication with a first input of a switch 597. An output of the intra prediction module 560 is connected in signal communication with a second input of the switch 597. An output of the switch 597 is connected in signal communication with a first non-inverting input of the combiner 525.

An input of the input buffer 510 is available as an input of the decoder 500, for receiving an input bitstream. A first output of the deblocking filter 565 is available as an output of the decoder 500, for outputting an output picture.

### SUMMARY

These and other drawbacks and disadvantages of the prior art are addressed by the present principles, which are directed to methods and apparatus for de-artifact filtering using multi-lattice sparsity-based filtering.

According to an aspect of the present principles, there is provided an apparatus. The apparatus includes a sparsity-based filter for de-artifact filtering picture data for a picture. The picture data includes different sub-lattice samplings of the picture. Sparsity-based filtering thresholds for the filter are varied temporally.

According to another aspect of the present principles, there is provided a method. The method includes de-artifact filtering picture data for a picture. The picture data includes different sub-lattice samplings of the picture. Sparsity-based filtering thresholds for the filtering are varied temporally.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram showing a decomposition of a rectangular grid into two complementary quincunx lattices, in accordance with the prior art;

FIG. 2 is block diagram for a direction-adaptive de-artifact filter, in accordance with the prior art;

FIG. 3 is a flow diagram for a method for direction-adaptive de-artifact filtering, in accordance with the prior art;

FIG. 4 is a block diagram for an exemplary encoder capable of performing video encoding;

FIG. 5 is a block diagram for an exemplary decoder capable of performing video decoding;

FIG. 6 is a block diagram for an exemplary out-loop direction-adaptive de-artifacting filter for an encoder, in accordance with an embodiment of the present principles;

FIG. 7 is a flow diagram for an exemplary method for out-loop direction-adaptive de-artifact filtering at an encoder, in accordance with an embodiment of the present principles;

FIG. 8 is a block diagram for an exemplary out-loop direction-adaptive de-artifacting filter for a decoder, in accordance with an embodiment of the present principles;

FIG. 9 is a flow diagram for an exemplary method for out-loop direction-adaptive de-artifact filtering at a decoder, in accordance with an embodiment of the present principles;

FIG. 10 shows a block diagram for an exemplary video encoder capable of performing video encoding, extended for use with the present principles, in accordance with an embodiment of the present principles;

FIG. 11 shows a block diagram for an exemplary video decoder capable of performing video decoding, extended for use with the present principles, in accordance with an embodiment of the present principles;

FIG. 12 shows a block diagram for an exemplary in-loop direction-adaptive de-artifacting filter for an encoder, in accordance with an embodiment of the present principles;

FIG. 13 shows a flow diagram for an exemplary method for in-loop direction-adaptive de-artifact filtering at an encoder, in accordance with an embodiment of the present principles;

FIG. 14 shows a block diagram for an exemplary in-loop direction-adaptive de-artifacting filter for a decoder, in accordance with an embodiment of the present principles;

FIG. 15 is a flow diagram for an exemplary method for in-loop direction-adaptive de-artifact filtering at a decoder, in accordance with an embodiment of the present principles;

FIG. 16 is a block diagram for another exemplary video encoder capable of performing video encoding, extended for use with the present principles, in accordance with an embodiment of the present principles; and

FIG. 17 shows a block diagram for another exemplary video decoder capable of performing video decoding, extended for use with the present principles, in accordance with an embodiment of the present principles.

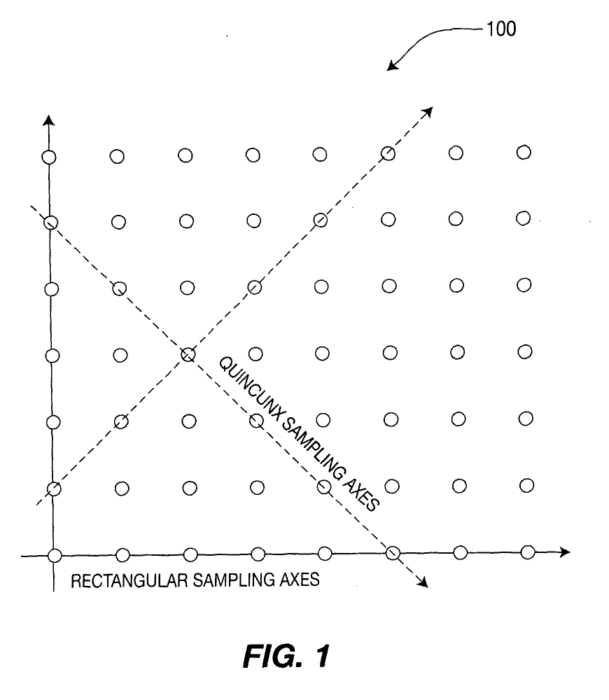

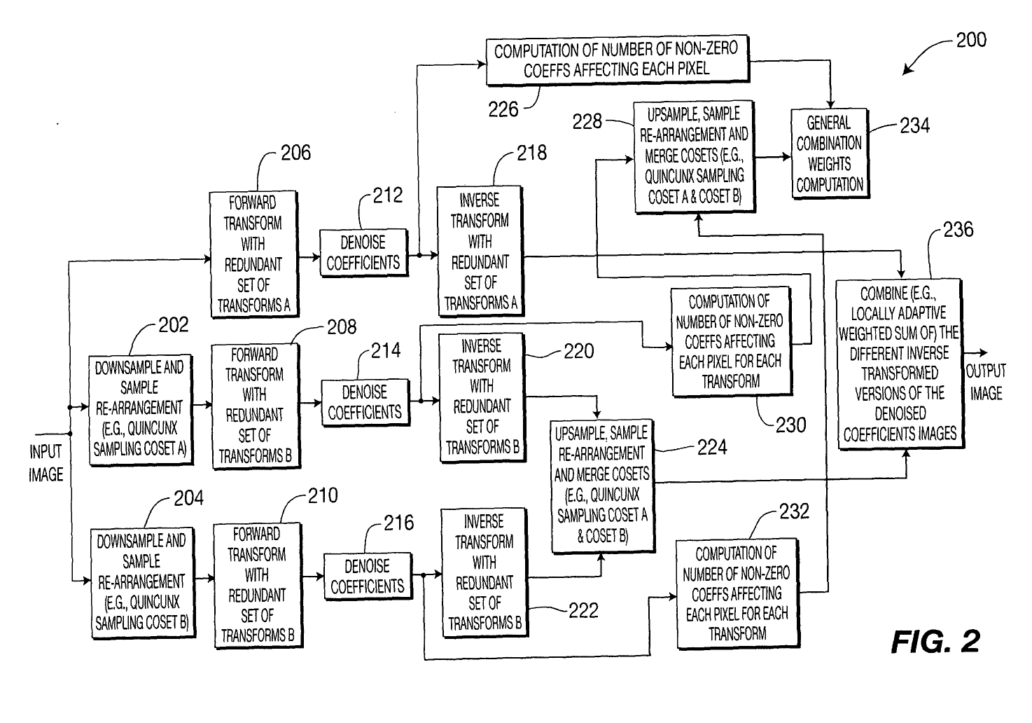

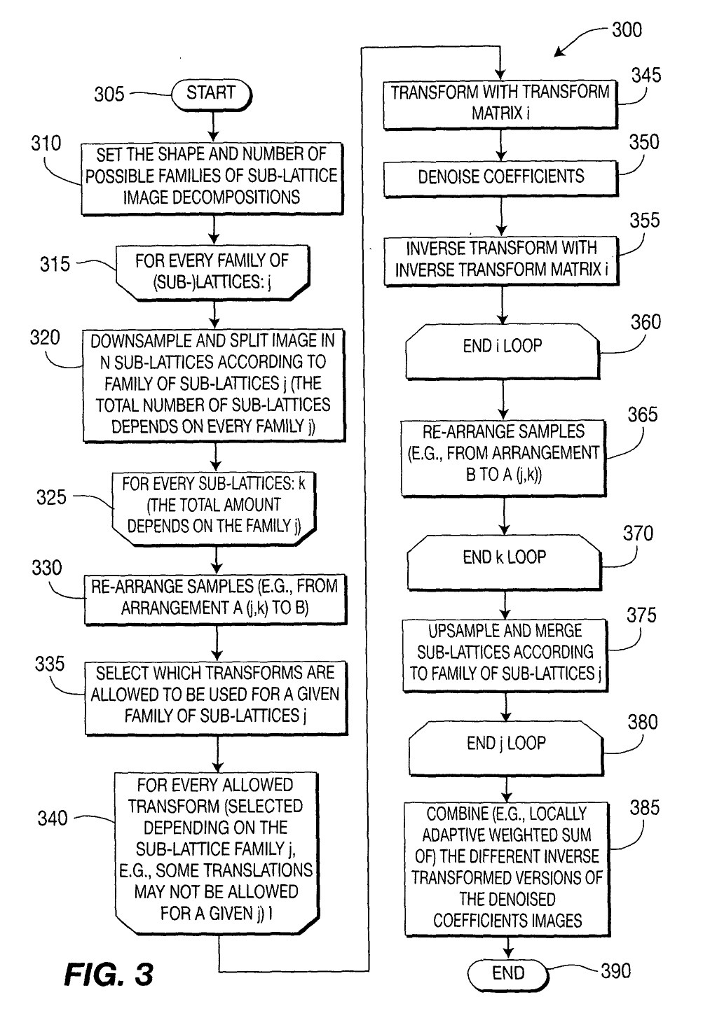

### DETAILED DESCRIPTION

The present principles are directed to methods and apparatus for de-artifact filtering using multi-lattice sparsity-based filtering.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

As used herein, the term “picture” refers to images and/or pictures including images and/or pictures relating to still and motion video.

Moreover, as used herein, the term “sparsity” refers to the case where a signal has few non-zero coefficients in the transformed domain. As an example, a signal with a transformed representation with 5 non-zero coefficients has a sparser representation than another signal with 10 non-zero coefficients using the same transformation framework.

Further, as used herein, the terms “lattice” or “lattice-based”, as used with respect to a sub-sampling of a picture, and equivalently “sub-lattice sampling”, refer to a sub-sampling where samples would be selected according to a given structured pattern of spatially continuous and/or non-continuous samples. In an example, such pattern may be a geometric pattern such as a rectangular pattern.

Also, as used herein, the term “local” refers to the relationship of an item of interest (including, but not limited to, a measure of average amplitude, average noise energy or the derivation of a measure of weight), relative to pixel location level, and/or an item of interest corresponding to a pixel or a localized neighborhood of pixels within a picture.

Additionally, as used herein, the term “global” refers to the relationship of an item of interest (including, but not limited to, a measure of average amplitude, average noise energy or the derivation of a measure of weight) relative to picture level, and/or an item of interest corresponding to the totality of pixels of a picture or sequence.

Moreover, as used herein, “high level syntax” refers to syntax present in the bitstream that resides hierarchically above the macroblock layer. For example, high level syntax, as used herein, may refer to, but is not limited to, syntax at the slice header level, Supplemental Enhancement Information (SEI) level, Picture Parameter Set (PPS) level, Sequence Parameter Set (SPS) level and Network Abstraction Layer (NAL) unit header level.

Moreover, it is to be appreciated that while one or more embodiments of the present principles are described herein with respect to the MPEG-4 AVC standard, the present principles are not limited to solely this standard and, thus, may be utilized with respect to other video coding standards, recommendations, and extensions thereof, including extensions of the MPEG-4 AVC standard, while maintaining the spirit of the present principles.

As noted above, the present principles are directed to methods and apparatus for de-artifact filtering using multi-lattice sparsity-based filtering.

Advantageously, one or more embodiments of the present principles are directed to high-performance de-artifact filtering based on sparsity-based filtering on different sub-lattice samplings of the picture using spatio-temporally adaptive thresholds for the filtering. For example, in an embodiment, filtering is based on the weighted combination of several sparsity-based filtering steps applied to different sub-lattice samplings of the picture to be filtered. Thresholds for the sparsity-based filtering steps are adapted in space and time in order to best fit the statistics of quantization noise and/or other parameters. For example, the present principles adapt the filtering thresholds depending on at least one of, but not limited to: signal characteristics; coding configurations (in-loop filtering and/or out-loop filtering); prediction modes; quantization noise statistics; local coding modes of the decoded pictures and the original signal; compression parameters; compression requirements; coding performance; a user selection (for example, a sharper image or a smoother image); and a measure of quality and/or a measure of coding cost. Of course, the preceding parameters upon which the filtering thresholds are adapted are merely illustrative and, given the teachings of the present principles provided herein, one of ordinary skill in this and related arts will contemplate these and various other parameters upon which the filtering thresholds are adapted, while maintaining the spirit of the present principles.

The present principles extend the applicability and improve the performance of sparsity-based filters for de-artifacting decoded video pictures. Sparsity-based filtering techniques using over-complete transforms provide robust mechanisms for reducing quantization noise particularly around edges, textures, and other singularities. However, performance of these techniques is largely dependent on the selection of appropriate filtering thresholds which must reflect a wide range of signal, coding and filtering characteristics. Advantageously, the present principles provide flexibility in that they may be implemented as an in-loop filter configuration, as well as a post-filtering and/or out-loop filter configuration. Selected thresholds are encoded and may be transmitted as side information to the decoder. The use of the present principles provides significant bit-rate savings and visual quality enhancements.

### Out-of-Loop Filtering

Post-filtering strategies have been commonly applied towards the enhancement of decoded video signals. The post-filter, referred to as “out-of-loop” or “out-loop”, is situated outside of the hybrid video coding loop. The present principles modify the direction-adaptive de-artifacting filter of the third prior art approach to out-loop filtering of decoded video. For this purpose, efficient coding of video sequences involves the adaptive selection of filtering thresholds. In accordance with the present principles we adapt the filtering thresholds in space and/or time.

As out-loop filters do not take part in the video coding loop, reference frames used in temporal prediction remain unaltered by the filtering results. Unlike in-loop filtering strategies such as those present in the MPEG-4 AVC Standard, out-loop filtering allows for a reduction of the processing delay of the coding loop. Indeed, no filtering operation on reference frames is required in order to decode later encoded frames. In a typical encoding scenario, the first frame, encoded in intra mode, is subject to noise and compression artifact's. The encoding of subsequent frames use noisy and artifact prone data for motion compensated prediction. Thus, artifacts, either introduced through intra encoding or inherited by repeating corrupted reference data, are pervasive throughout each frame of the decoded video sequence regardless of encoding mode.

The direction-adaptive de-artifacting filter of the third prior art approach has been demonstrated to operate efficiently over intra encoded frames. As previously mentioned, assumptions regarding quantization noise and the presence of artifacts in intra frames may be extended to temporally encoded frames when in-loop filtering is suppressed. Under such circumstances, the direction-adaptive de-artifacting filter when adapted to out-loop filtering has the potential to successfully combat compression artifacts within each frame of the decoded video sequence.

In an embodiment, referred to as the out-loop direction-adaptive de-artifacting filter, non-stationary signal characteristics are considered. For example, an alteration of scene content over time may involve distinct filtering thresholds in order to sustain performance. Thresholds are therefore generated and separately selected for each frame while encoding.

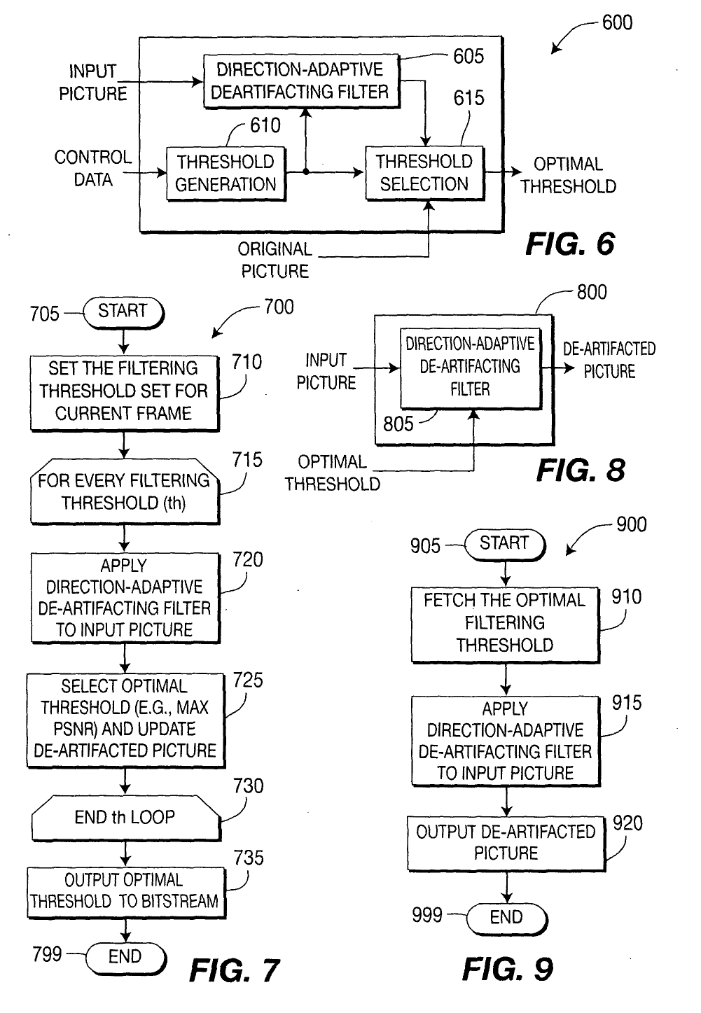

Turning to FIG. 6, an exemplary out-loop direction-adaptive de-artifacting filter for an encoder is indicated generally by the reference numeral 600. The filter 600 includes a threshold generator 610 having an output connected in signal communication with a first input of a direction-adaptive de-artifacting filter 605 and a first input of a threshold selector 615. An output of the direction-adaptive de-artifacting filter 605 is connected in signal communication with a second input of the threshold selector 615. A second input of the direction-adaptive de-artifacting filter 605 is available as an input of the filter 600, for receiving an input picture. An input of the threshold generator 610 is available as an input of the filter 600, for receiving control data. A third input of the threshold selector 615 is available as an input of the filter 600, for receiving an original picture. An output of the threshold selector 615 is available as an output of the filter 600, for outputting an optimal threshold.

Turning to FIG. 7, an exemplary method for out-loop direction-adaptive de-artifact filtering at an encoder is indicated generally by the reference numeral 700. The method 700 includes a start block 705 that passes control to a function block 710. The function block 710 sets a filtering threshold set for a current frame, and passes control to a loop limit block 715. The loop limit block 715 performs a loop for every filtering threshold (th), and passes control to a function block 720. The function block 720 applies a direction-adaptive de-artifacting filter to an input picture, and passes control to a function block 725. The function block 725 selects an optimal threshold (e.g., maximum peak signal to noise ratio (PSNR)), updates the de-artifacted picture, and passes control to a loop limit block 730. The loop limit block 730 ends the loop for every filtering threshold, and passes control to a function block 735. The function block 735 outputs an optimal threshold to a bitstream, and passes control to an end block 799.

Referring back to FIG. 6, the threshold generator 610 uses control data to define a set from which an optimal threshold is selected, for example, by maximizing at least one of a measure of encoding quality, coding cost or joint encoding quality and cost. Control data may consider, but may not be limited to, compression parameters (e.g., QP), user preferences and/or signal structure and statistics. It is to be appreciated that the preceding items considered with respect to the control data are merely illustrative and, thus, given the teachings of the present principles provided herein, one of ordinary skill in this and related arts will contemplate these and various other items relating to the control data, while maintaining the spirit of the present principles. Since the threshold selector 615 uses information only available at the encoder side (original image I), the selected thresholds are transmitted in the bitstream of the video coding scheme. The decoder then extracts this information from the bitstream in order to de-artifact the decoded signal with the proper out-loop filter.

Turning to FIG. 8, an exemplary out-loop direction-adaptive de-artifacting filter for a decoder is indicated generally by the reference numeral 800. The filter 800 includes a direction-adaptive de-artifacting filter 805. A first input of the direction-adaptive de-artifacting filter 805 is available as an input of the filter 800, for receiving an input picture. A second input of the direction-adaptive de-artifacting filter 805 is available as an input of the filter 800, for receiving an optimal threshold. An output of the direction-adaptive de-artifacting filter 805 is available as an output of the filter 800, for outputting a de-artifacted picture.

Turning to FIG. 9, an exemplary method for out-loop direction-adaptive de-artifact filtering at a decoder is indicated generally by the reference numeral 900.

The method 900 includes a start block 905 that passes control to a function block 910. The function block 910 fetches the optimal filtering threshold, and passes control to a function block 915. The function block 915 applies a direction-adaptive de-artifacting filter to an input picture, and passes control to a function block 920. The function block 920 outputs a de-artifacted picture, and passes control to an end block 999.

Encoding, transmission and decoding of filtering thresholds can be done at different levels of the data units of a video stream. A threshold can apply to a picture region, a picture, and/or a whole sequence. Mechanisms to define this can be introduced within the bitstream using, for example, but not limited to, one or more high level syntax elements.

In an embodiment, a threshold per slice can be encoded. This threshold can be encoded with simple uniform codes but it is not limited in such a manner. For example, they can be differentially encoded with respect to previous slices and/or video frames. Also an average threshold value that depends on, for example, but not limited to, coding settings, encoding profile and/or quantization parameter can be known at the encoder and decoder. The adaptive threshold can be encoded differentially with respect to this average threshold. Uniform coded values and/or differential values can then be encoded using, for example, but not limited to, uniform codes, variable length codes (VLC) and/or arithmetic coding (e.g., context adaptive arithmetic binary coding (CABAC)). In an embodiment, information regarding the selected thresholds for each slice/frame/sequence is transmitted within the coded video bit-stream as Supplemental Enhancement Information data and/or some other high level syntax element(s).

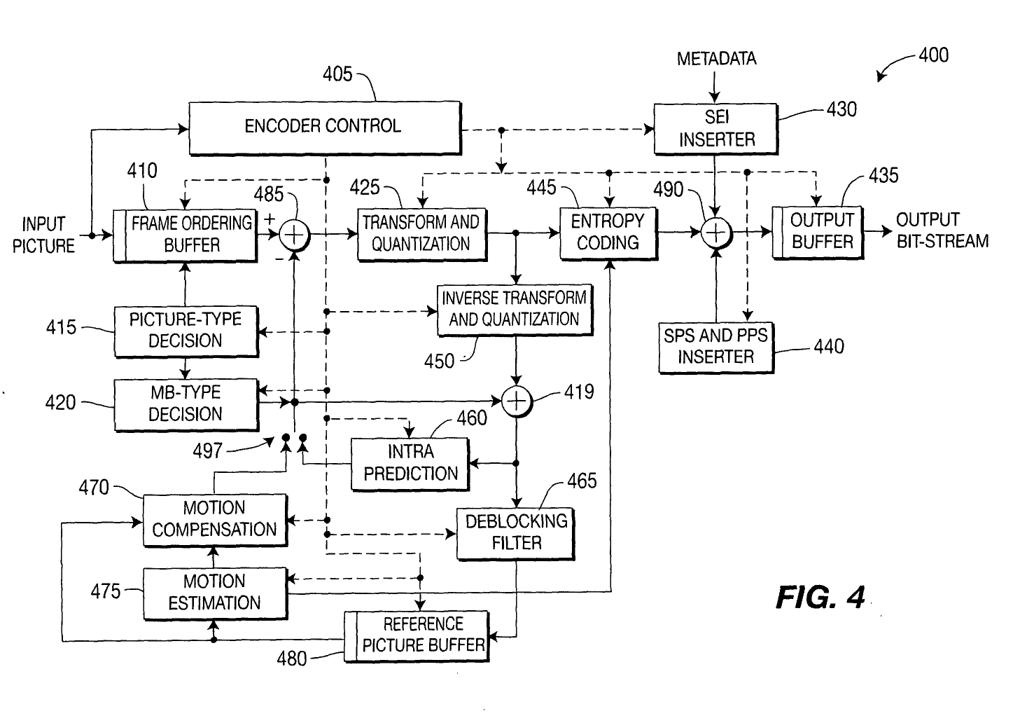

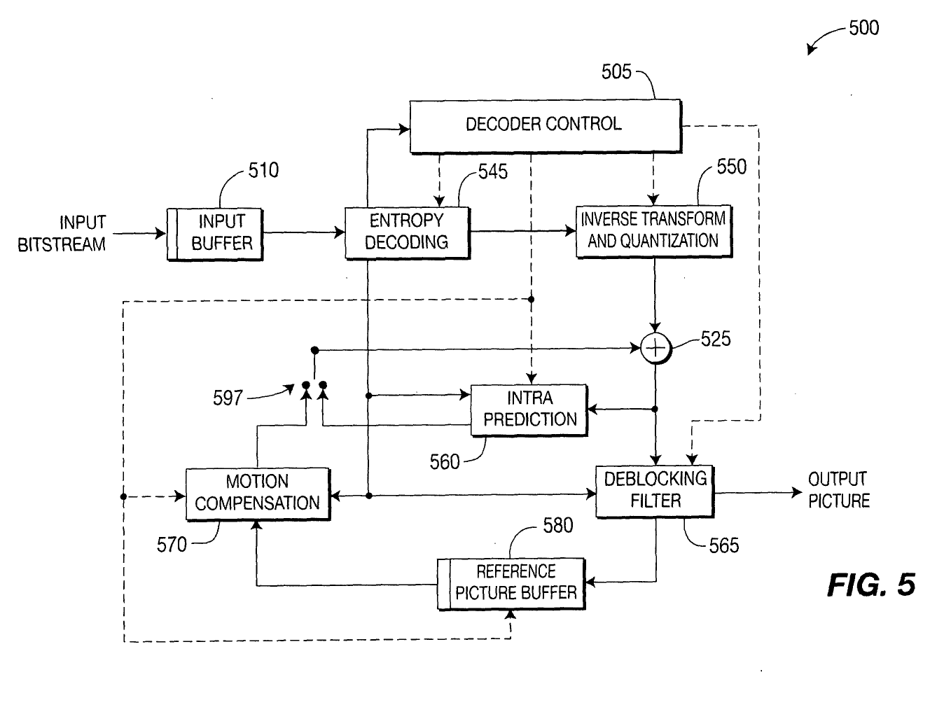

In an embodiment, a post-filter for reconstructed data can be applied to the MPEG-4 AVC Standard. In such an embodiment, the MPEG-4 AVC Standard deblocking filter within the standard encoder and decoder, as shown and described with respect to FIGS. 4 and 5, respectively, can be disabled while the out-loop direction-adaptive de-artifacting filter is operating.

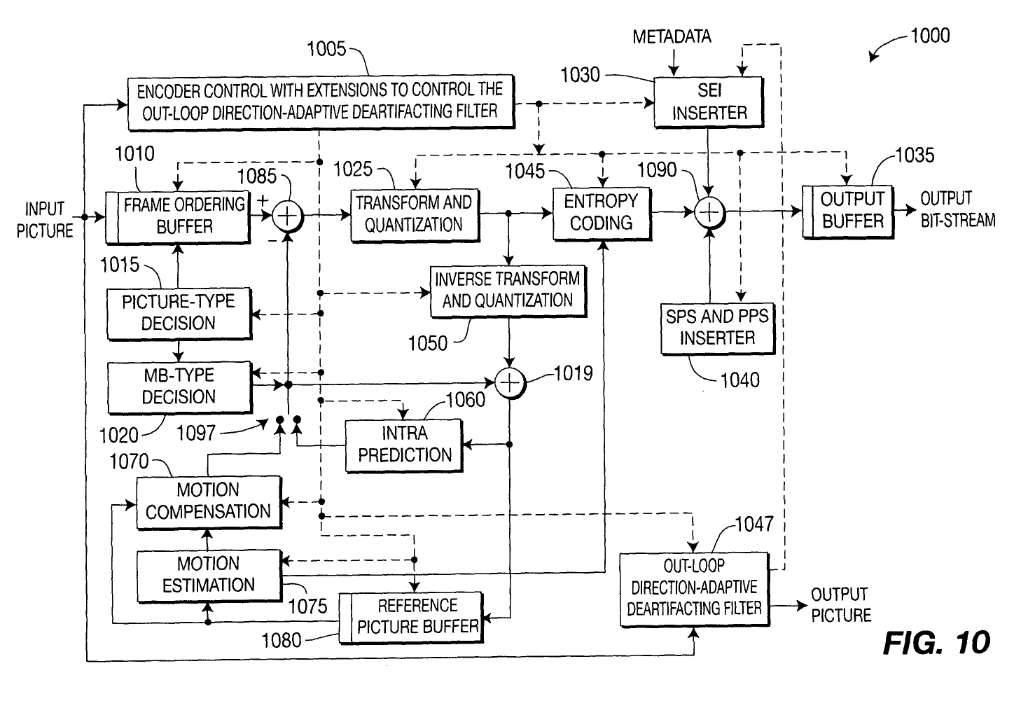

Turning to FIG. 10, an exemplary video encoder capable of performing video encoding in accordance with the MPEG-4 AVC standard, extended for use with the present principles, is indicated generally by the reference numeral 1000. The extensions applied to video encoder 1000 provide support for out-loop direction-adaptive de-artifact filtering.

The video encoder 1000 includes a frame ordering buffer 1010 having an output in signal communication with a non-inverting input of a combiner 1085. An output of the combiner 1085 is connected in signal communication with a first input of a transformer and quantizer 1025. An output of the transformer and quantizer 1025 is connected in signal communication with a first input of an entropy coder 1045 and a first input of an inverse transformer and inverse quantizer 1050. An output of the entropy coder 1045 is connected in signal communication with a first non-inverting input of a combiner 1090. An output of the combiner 1090 is connected in signal communication with a first input of an output buffer 1035.

A first output of an encoder controller 1005 with extensions (to control out-loop direction-adaptive de-artifacting filter 1047) is connected in signal communication with a second input of the frame ordering buffer 1010, a second input of the inverse transformer and inverse quantizer 1050, an input of a picture-type decision module 1015, a first input of a macroblock-type (MB-type) decision module 1020, a second input of an intra prediction module 1060, a first input of a motion compensator 1070, a first input of a motion estimator 1075, a second input of a reference picture buffer 1080, and a third input of an out-loop direction-adaptive de-artifacting filter 1047.

A second output of the encoder controller 1005 with extensions (to control out-loop direction-adaptive de-artifacting filter 1047) is connected in signal communication with a first input of a Supplemental Enhancement Information (SEI) inserter 1030, a second input of the transformer and quantizer 1025, a second input of the entropy coder 1045, a second input of the output buffer 1035, and an input of the Sequence Parameter Set (SPS) and Picture Parameter Set (PPS) inserter 1040.

An output of the SEI inserter 1030 is connected in signal communication with a second non-inverting input of the combiner 1090.

A first output of the picture-type decision module 1015 is connected in signal communication with a third input of a frame ordering buffer 1010. A second output of the picture-type decision module 1015 is connected in signal communication with a second input of a macroblock-type decision module 1020.

An output of the Sequence Parameter Set and Picture Parameter Set inserter 1040 is connected in signal communication with a third non-inverting input of the combiner 1090.

An output of the inverse quantizer and inverse transformer 1050 is connected in signal communication with a first non-inverting input of a combiner 1019. An output of the combiner 1019 is connected in signal communication with a first input of the intra prediction module 1060, a first input of the out-loop direction-adaptive de-artifacting filter 1047, and a first input of a reference picture buffer 1080. An output of the reference picture buffer 1080 is connected in signal communication with a second input of the motion estimator 1075 and with a third input of the motion compensator 1070. A first output of the motion estimator 1075 is connected in signal communication with a second input of the motion compensator 1070. A second output of the motion estimator 1075 is connected in signal communication with a third input of the entropy coder 1045. A second output of the out-loop direction-adaptive de-artifacting filter 1047 is connected in signal communication with a third input of the SEI inserter 1030.

An output of the motion compensator 1070 is connected in signal communication with a first input of a switch 1097. An output of the intra prediction module 1060 is connected in signal communication with a second input of the switch 1097. An output of the macroblock-type decision module 1020 is connected in signal communication with a third input of the switch 1097. The third input of the switch 1097 determines whether or not the “data” input of the switch (as compared to the control input, i.e., the third input) is to be provided by the motion compensator 1070 or the intra prediction module 1060. The output of the switch 1097 is connected in signal communication with a second non-inverting input of the combiner 1019 and with an inverting input of the combiner 1085.

A first input of the frame ordering buffer 1010, an input of the encoder controller 1005 with extensions (to control out-loop direction-adaptive de-artifacting filter 1047), and a second input of the out-loop direction-adaptive de-artifacting filter 1047 are available as input of the encoder 1000, for receiving an input picture. Moreover, a second input of the Supplemental Enhancement Information (SEI) inserter 1030 is available as an input of the encoder 1000, for receiving metadata. An output of the output buffer 1035 is available as an output of the encoder 1000, for outputting a bitstream. A first output of the out-loop direction-adaptive de-artifacting filter 1047 is available as an output of the encoder 1000, for outputting a filtered picture.

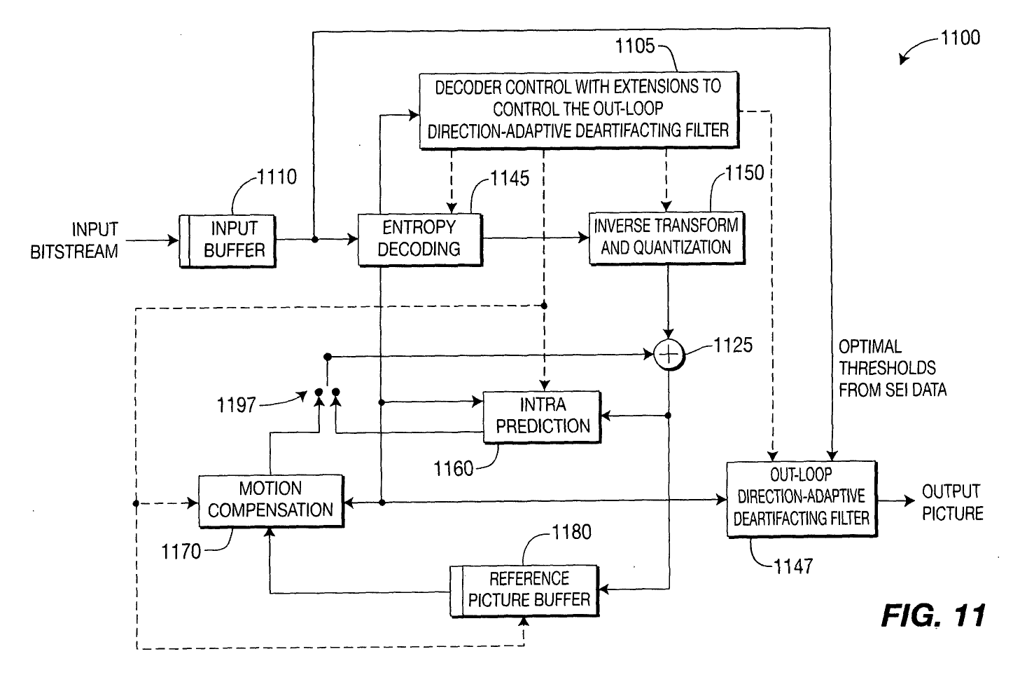

Turning to FIG. 11, an exemplary video decoder capable of performing video decoding in accordance with the MPEG-4 AVC Standard, extended for use with the present principles, is indicated generally by the reference numeral 1100. The extensions applied to video decoder 1100 provide support for out-loop direction-adaptive de-artifact filtering.

The video decoder 1100 includes an input buffer 1110 having an output connected in signal communication with a first input of the entropy decoder 1145 and with a third input of an out-loop direction-adaptive de-artifacting filter 1147. A first output of the entropy decoder 1145 is connected in signal communication with a first input of an inverse transformer and inverse quantizer 1150. An output of the inverse transformer and inverse quantizer 1150 is connected in signal communication with a second non-inverting input of a combiner 1125. An output of the combiner 1125 is connected in signal communication with a first input of an intra prediction module 1160 and a first input of a reference picture buffer 1180. An output of the reference picture buffer 1180 is connected in signal communication with a second input of a motion compensator 1170.

A second output of the entropy decoder 1145 is connected in signal communication with a third input of the motion compensator 1170 and a first input of the out-loop direction-adaptive de-artifacting filter 1147. A third output of the entropy decoder 1145 is connected in signal communication with an input of a decoder controller 1105 with extensions (to control out-loop direction-adaptive de-artifacting filter 1147). A first output of the decoder controller 1105 with extensions (to control out-loop direction-adaptive de-artifacting filter 1147) is connected in signal communication with a second input of the entropy decoder 1145. A second output of the decoder controller 1105 with extensions (to control out-loop direction-adaptive de-artifacting filter 1147) is connected in signal communication with a second input of the inverse transformer and inverse quantizer 1150. A third output of the decoder controller 1105 with extensions (to control out-loop direction-adaptive de-artifacting filter 1147) is connected in signal communication with a second input of the out-loop direction-adaptive de-artifacting filter 1147. A fourth output of the decoder controller 1105 with extensions (to control out-loop direction-adaptive de-artifacting filter 1147) is connected in signal communication with a second input of the intra prediction module 1160, with a first input of the motion compensator 1170, and with a second input of the reference picture buffer 1180.

An output of the motion compensator 1170 is connected in signal communication with a first input of a switch 1197. An output of the intra prediction module 1160 is connected in signal communication with a second input of the switch 1197. An output of the switch 1197 is connected in signal communication with a first non-inverting input of the combiner 1125.

An input of the input buffer 1110 is available as an input of the decoder 1100, for receiving an input bitstream. An output of the out-loop direction-adaptive de-artifacting filter 1147 is available as an output of the decoder 1100, for outputting a picture. A third input of the out-loop direction-adaptive de-artifacting filter 1147 is available as an input of the decoder 1100, for receiving optimal thresholds from SEI data.

The encoder controller 805 and the decoder controller 905, relating to FIGS. 8 and 9, respectively, are both modified to obtain the encoder controller 1005 and the decoder controller 1105 with extensions to control the out-loop direction adaptive filter (namely filter 1047 and filter 1147, respectively). This has a consequence relating to the possible requirement of block level syntax and/or high level syntax for setting, configuring, and adapting the out-loop filter for the most efficient operation. For this purpose several syntax fields may be defined at different levels. TABLE 1 shows exemplary picture parameter set syntax data for out-loop and in-loop direction-adaptive de-artifact filtering, in accordance with an embodiment. TABLE 2 shows exemplary slice header data for out-loop and in-loop direction-adaptive de-artifact filtering, in accordance with an embodiment. Of course, other high level syntax elements may also be used for setting, configuring, and adapting the out-loop filter, while maintaining the spirit of the present principles. In an embodiment, coded thresholds can be embedded into the slice header in order to properly set the filter at the decoder side.

TABLE 1

| | | |
|---|---|---|
| pic_parameter_set_rbsp( ){ | C | Descriptor |

...

| | | |
|---|---|---|
| deart_filter_control_flag | 1 | u(1) |
| if(deart_filter_control_flag){ | | |

| | | |
|---|---|---|
| enable_threshold_generation_type | 1 | u(1) |
| enable_threshold_selection_type | 1 | u(1) |
| enable_map_creation_type | 1 | u(1) |

}

...
}

TABLE 2

| | | |
|---|---|---|
| slice_header( ){ | C | Descriptor |

...
if(deart_filter_control_flag){

| | | |
|---|---|---|
| selection_filter_type | 2 | u(v) |
| if(selection_filter_type){ | | |

| | | |
|---|---|---|
| if(enable_threshold_generation_type) | 2 | u(v) |

threshold_generation_type

| | | |
|---|---|---|
| if(enable_threshold_selection_type) | 2 | u(v) |

threshold_selection_type

}
if(selection_filter_type == 2){

| | | |
|---|---|---|
| if(enable_map_creation_type) | 2 | u(v) |
| map_creation_type | | |

}

}
...
}

Some of the syntax elements shown in TABLES 1 and 2 will now be described, in accordance with an embodiment.

deart_filter_present_flag: If equal to 1, specifies that a set of syntax elements controlling the characteristics of the direction-adaptive de-artifacting filter is present in the slice header. If equal to 0, specifies that a set of syntax elements controlling the characteristics of the direction-adaptive de-artifacting filter is not present in the slice header and their inferred values are in effect.

selection_filter_type: specifies the filter configuration used in de-artifacting. If equal to 0, specifies that direction-adaptive de-artifact filtering shall be disabled. If equal to 1, specifies that out-loop direction-adaptive de-artifact filtering is used. If equal to 2, specifies that in-loop direction-adaptive de-artifact filtering is used.

enable_threshold_generation_type, enable_threshold_selection_type: are high level syntax values that can be located, for example, but not limited to, the sequence parameter set and/or picture parameter set levels. In an embodiment, these values enable the possibility to change the default values for the filter type, threshold generation form, and threshold selection method.

threshold_generation_type: specifies which set of thresholds is used in direction-adaptive de-artifacting. For example, in an embodiment, this set may depend on compression parameters, user preferences, and/or signal characteristics.

threshold_selection_type: specifies which method of optimal threshold selection is used in encoding with the direction-adaptive de-artifacting filter. For example, in an embodiment, one may maximize encoding quality, coding cost, or joint encoding quality and cost.

### In-Loop Filtering

One advantage of in-loop filtering is the ability of the video coder to use filtered reference frames for motion estimation and compensation. This filtering configuration can improve both objective and subjective quality of the video streams when compared to out-loop filtering alternatives. Nevertheless, indiscriminate filtering will implicate image areas repeated from previously filtered reference frames. In order to avoid possible over-filtering of such areas, an in-loop implementation of the direction-adaptive de-artifacting filter must be locally adaptive, respecting encoding differences at the block level as well as at the pixel level.

Temporally encoded blocks within a typical hybrid video encoder are subject to various local encoding modes and conditions which contribute to different quantization noise statistics. Three distinct block encoding modes or conditions may be identified: (1) intra encoding; (2) inter encoding with coding of residuals; and (3) inter encoding with no coded residuals.

The first two cases involve different modes of predictive coding and their quantization effects. Additionally, the boundaries between such blocks are subject to blocking artifacts of varying severity. Based on the filtering strength observations of the MPEG-4 AVC Standard deblocking filter, boundaries of inter encoded blocks with no coded residual which present either differences of block motion of more than one pixel or motion compensation from different reference frames, are also susceptible to blocking artifacts.

The conditions described above may be used to identify and isolate image areas which call for dedicated filtering strategies. Each pixel of a luminance image is grouped into a particular class in accordance to the local encoding conditions. In an exemplary embodiment, the conditions are evaluated from top to bottom, indicating pixels within the elected blocks or along the boundaries of such blocks. In the instant embodiment, it is noted that a pixel is considered to belong to a boundary of a block if it is within a distance d of the block edge.

The classification gives rise to a filtering map which provides a localized discrimination of the image areas subject to distinct quantization effects. In an embodiment, referred to as the in-loop direction-adaptive de-artifacting filter, a map creation module is responsible for carrying out the above classification and producing a filtering map for each frame of the video sequence. Filtering Maps for the chroma components of an image are obtained via sub-sampling of the luminance maps.

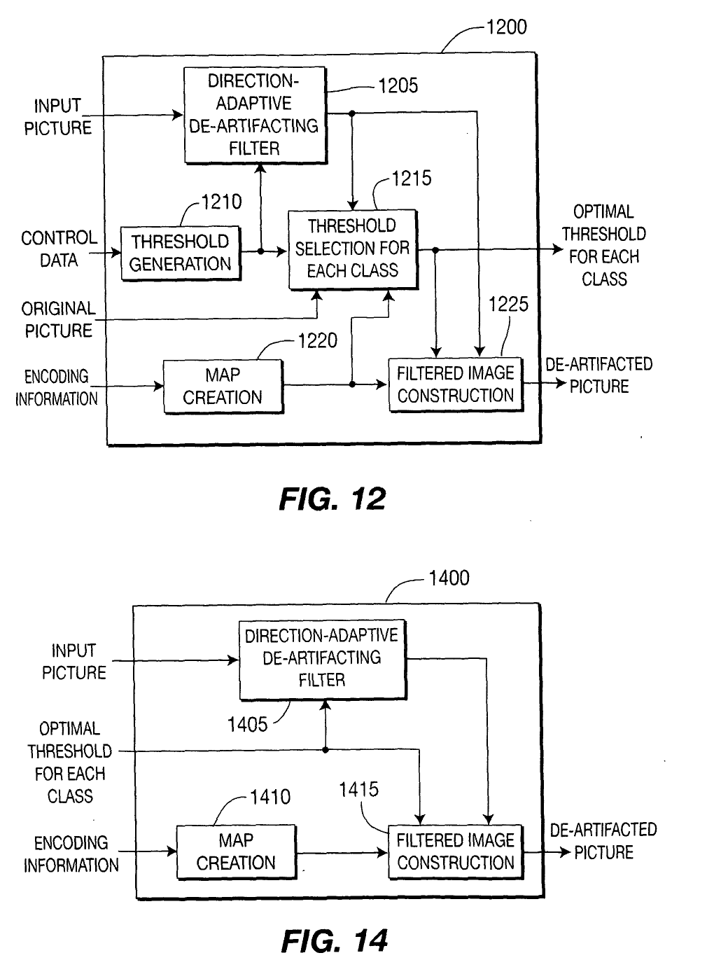

Turning to FIG. 12, an exemplary in-loop direction-adaptive de-artifacting filter for an encoder is indicated generally by the reference numeral 1200. The filter 1200 includes a direction-adaptive de-artifacting filter 1205 having an output in signal communication with a second input of a threshold selector (for each class) 1215 and a third input of a filtered image constructor 1225. An output of the threshold selector 1215 is connected in signal communication with a second input of the filtered image constructor 1225. An output of a threshold generator 1210 is connected in signal communication with a first input of the threshold selector 1215 and a second input of the direction-adaptive de-artifacting filter 1205. An output of a map creator 1220 is connected in signal communication with a fourth input of the threshold selector 1215 and a first input of the filtered image constructor 1225. A first input of the direction-adaptive de-artifacting filter 1205 is available as an input of the filter 1200, for receiving an input picture. An input of the threshold generator 1210 is available as an input of the filter 1200, for receiving control data. A third input of the threshold selector 1215 is available as an input of the filter 1200, for receiving an original picture. An input of the map creator 1220 is available as an input of the filter 1200, for receiving encoding information. The output of the threshold selector 1215 is also available as an output of the filter 1200, for outputting an optimal threshold for each class. An output of the filtered image constructor 1225 is available as an output of the filter 1200, for outputting a de-artifacted picture.

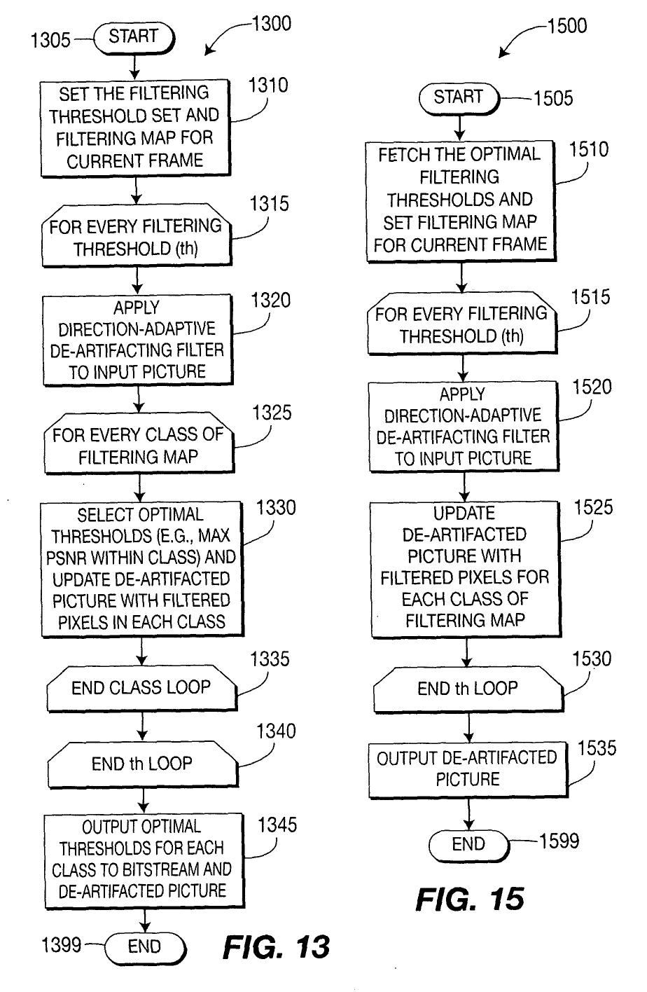

Turning to FIG. 13, an exemplary method for in-loop direction-adaptive de-artifact filtering at an encoder is indicated generally by the reference numeral 1300. The method 1300 includes a start block 1305 that passes control to a function block 1310. The function block 1310 sets the filtering threshold set and the filtering map for a current frame, and passes control to a loop limit block 1315. The loop limit block 1315 performs a loop for every filtering threshold (th), and passes control to a function block 1320. The function block 1320 applies direction-adaptive de-artifact filtering to an input picture, and passes control to a loop limit block 1325. The loop limit block 1325 performs a loop for every class of the filtering map, and passes control to a function block 1330. The function block 1330 selects optimal thresholds (e.g., max PSNR), updates a de-artifacted picture with filtered pixels in each class, and passes control to a loop limit block 1335. The loop limit block 1335 ends the loop for every class, and passes control to a loop limit block 1340. The loop limit block 1340 ends the loop for every filtering threshold (th), and passes control to a function block 1345. The function block 1345 outputs optimal thresholds for each class to a bitstream, outputs a de-artifacted picture, and passes control to an end block 1399.

With the aid of filtering maps, in an embodiment, dedicated filtering thresholds are applied in de-artifacting of pixels within each of the indicated classes. Referring back to FIG. 12, the threshold generator 1210 uses control data to define a set of thresholds which are applied towards direction-adaptive de-artifacting of the image during the encoding procedure. Control data may consider, but is not limited to, compression parameters (e.g., quantization parameter (QP)), user preferences, local and/or global signal characteristics, and/or local and/or global noise/distortion characteristics. Thresholds can be adaptively set such, for example, but not limited to, at least one of a video quality measure, coding cost measure, and joint quality are optimized. For example, for each class, an optimal threshold is selected such that the PSNR between filtered and original pixels within a class is maximized. It is to be appreciated that filtering operations under the various thresholds may be implemented in parallel. In an embodiment, one can use several independent filtering operations where each of the filtering operations uses one of the possible thresholds applicable to each class, in order to generate different filtered versions of the picture. The filter in such a case is based on the weighted combination of several sparsity-based filtering steps on different sub-lattice samplings of the picture to be filtered. In an embodiment, a composite image including the optimally filtered data for each class is constructed and made available to the remainder of the coding modules (e.g., by the filtered image constructor 1225). Since the threshold selector 1215 uses information only available at the encoder (original image), the selected thresholds for each class are transmitted in the bit-stream of the video coding scheme.

In an embodiment, selected thresholds per slice can be encoded. These thresholds can be, but are not limited to, encoding with simple uniform codes. For example, they can be differentially encoded with respect to previous slices and/or video frames. Also some average threshold value that depends on, for example, the coding settings, encoding profile and/or quantization parameter can be known at the encoder and decoder. The adaptive threshold can be encoded differentially with respect to this average threshold. Uniform coded values and/or differential values can then be encoded using, for example, but not limited to, uniform codes, variable length codes (VLC), and/or arithmetic coding (e.g., context adaptive arithmetic binary coding (CABAC)). In an embodiment, information regarding the selected thresholds for each slice/frame/sequence is transmitted within the coded video bit-stream as SEI (Supplemental Enhancement Information) data. One of ordinary skill in this and related arts will appreciate that other data units such as any high level syntax parameter set and/or header (e.g., slice parameter set, picture parameter set, sequence parameter set, and so forth) may also be used for threshold transmission.

The decoder also constructs a filtering map and, with the optimal threshold information extracted from the bit-stream, proceeds to de-artifact the pixels within each class accordingly. Direction-adaptive de-artifact filtering results are used in producing a filtered image where pixels within each class have been subject to a specific filtering threshold.

Turning to FIG. 14, an exemplary in-loop direction-adaptive de-artifacting filter for a decoder is indicated generally by the reference numeral 1400. The filter 1400 includes a direction-adaptive de-artifacting filter 1405 having an output connected in signal communication with a third input of a filtered image constructor 1415. An output of a map creator 1410 is connected in signal communication with a first input of the filtered image constructor 1415. An input of the direction-adaptive de-artifacting filter 1405 is available as an input of the filter 1400, for receiving an input picture. A second input of the direction-adaptive de-artifacting filter 1405 and a second input of the filtered image constructor 1415 are available as input of the filter 1400, for receiving an optimal threshold for each class. An input of the map creator 1410 is available as an input of the filter 1400, for receiving encoding information. An output of the filtered image constructor 1415 is available as an output of the filter 1400, for outputting a de-artifacted picture.

Turning to FIG. 15, an exemplary method for in-loop direction-adaptive de-artifact filtering at a decoder is indicated generally by the reference numeral 1500. The method 1500 includes a start block 1505 that passes control to a function block 1510. The function block 1510 fetches the optimal filtering thresholds and sets the filtering map for the current frame, and passes control to a loop limit block 1515. The loop limit block 1515 performs a loop for every filtering threshold (th), and passes control to a function block 1520. The function block 1520 applies the direction-adaptive de-artifacting filter to an input picture, and passes control to a function block 1525. The function block 1525 updates the de-artifacted picture with filtered pixels for each class of the filtering map, and passes control to a loop limit block 1530. The loop limit block 1530 ends the loop for every filtering threshold (th), and passes control to a function block 1535. The function block 1535 outputs a de-artifacted picture, and passes control to an end block 1599.

The in-loop direction-adaptive de-artifacting filter with spatio-temporally adaptive thresholds is embedded within the loop of a hybrid video encoder/decoder. The video encoder/decoder can be, for example as an extension of an MPEG-4 AVC Standard video encoder/decoder. In this case, the MPEG-4 AVC Standard deblocking filter can be substituted, complemented and/or disabled while the in-loop direction-adaptive de-artifacting filter is operating. Information regarding the selected thresholds for each class within a frame is transmitted within the coded video bit-stream as, for example, but not limited to, SEI (Supplemental Enhancement Information) data.

In an embodiment, an in-loop filter for reconstructed data can be applied to the MPEG-4 AVC Standard. In such a case, the MPEG-4 AVC Standard deblocking filter within the standard encoder and decoder, shown in FIGS. 8 and 9, can be disabled while the in-loop direction-adaptive de-artifacting filter is operating.

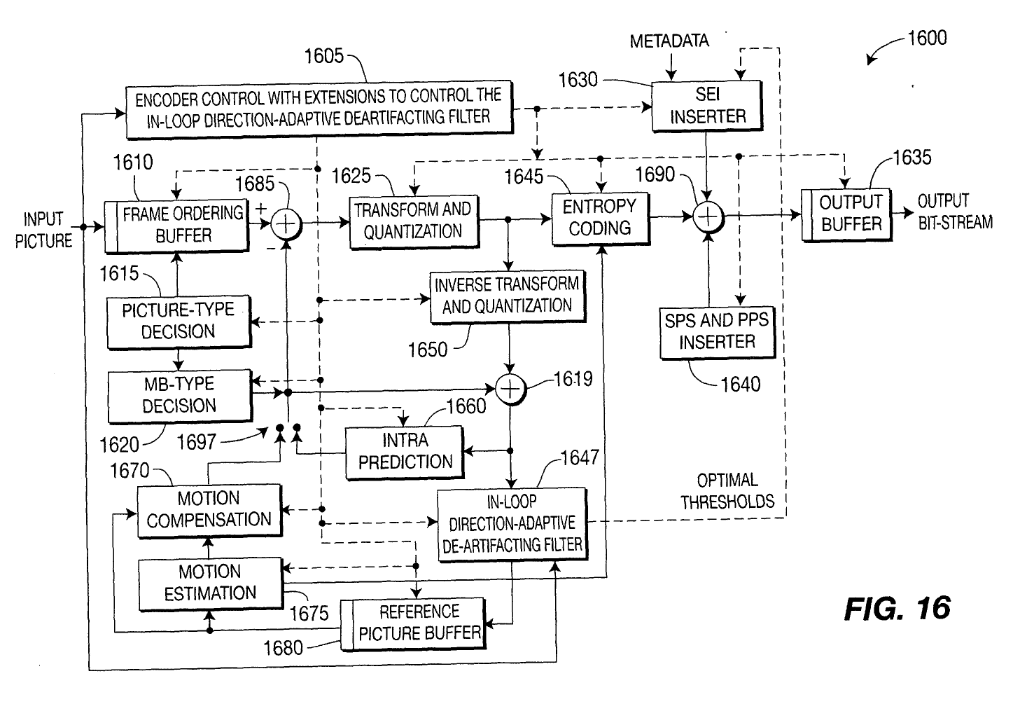

Turning to FIG. 16, another exemplary video encoder capable of performing video encoding in accordance with the MPEG-4 AVC Standard, extended for use with the present principles, is indicated generally by the reference numeral 1600. The extensions applied to video encoder 1600 provide support for in-loop direction-adaptive de-artifact filtering.

The video encoder 1600 includes a frame ordering buffer 1610 having an output in signal communication with a non-inverting input of a combiner 1685. An output of the combiner 1685 is connected in signal communication with a first input of a transformer and quantizer 1625. An output of the transformer and quantizer 1625 is connected in signal communication with a first input of an entropy coder 1645 and a first input of an inverse transformer and inverse quantizer 1650. An output of the entropy coder 1645 is connected in signal communication with a first non-inverting input of a combiner 1690. An output of the combiner 1690 is connected in signal communication with a first input of an output buffer 1635.

A first output of an encoder controller 1605 with extensions (to control in-loop direction adaptive de-artifacting filter 1647) is connected in signal communication with a second input of the frame ordering buffer 1610, a second input of the inverse transformer and inverse quantizer 1650, an input of a picture-type decision module 1615, a first input of a macroblock-type (MB-type) decision module 1620, a second input of an intra prediction module 1660, a second input of a in-loop direction-adaptive de-artifacting filter 1647, a first input of a motion compensator 1670, a first input of a motion estimator 1675, and a second input of a reference picture buffer 1680.

A second output of the encoder controller 1605 with extensions (to control in-loop direction adaptive de-artifacting filter 1647) is connected in signal communication with a first input of a Supplemental Enhancement Information (SEI) inserter 1630, a second input of the transformer and quantizer 1625, a second input of the entropy coder 1645, a second input of the output buffer 1635, and an input of the Sequence Parameter Set (SPS) and Picture Parameter Set (PPS) inserter 1640.

An output of the SEI inserter 1630 is connected in signal communication with a second non-inverting input of the combiner 1690.

A first output of the picture-type decision module 1615 is connected in signal communication with a third input of a frame ordering buffer 1610. A second output of the picture-type decision module 1615 is connected in signal communication with a second input of a macroblock-type decision module 1620.

An output of the Sequence Parameter Set (SPS) and Picture Parameter Set (PPS) inserter 1640 is connected in signal communication with a third non-inverting input of the combiner 1690.

An output of the inverse quantizer and inverse transformer 1650 is connected in signal communication with a first non-inverting input of a combiner 1619. An output of the combiner 1619 is connected in signal communication with a first input of the intra prediction module 1660 and a first input of the in-loop direction-adaptive de-artifacting filter 1647. A first output of the in-loop direction-adaptive de-artifacting filter 1665 is connected in signal communication with a first input of a reference picture buffer 1680. An output of the reference picture buffer 1680 is connected in signal communication with a second input of the motion estimator 1675 and with a third input of the motion compensator 1670. A first output of the motion estimator 1675 is connected in signal communication with a second input of the motion compensator 1670. A second output of the motion estimator 1675 is connected in signal communication with a third input of the entropy coder 1645. A second output of the in-loop direction-adaptive de-artifacting filter 1647 is connected in signal communication with a third input of the SEI inserter 1630.

An output of the motion compensator 1670 is connected in signal communication with a first input of a switch 1697. An output of the intra prediction module 1660 is connected in signal communication with a second input of the switch 1697. An output of the macroblock-type decision module 1620 is connected in signal communication with a third input of the switch 1697. The third input of the switch 1697 determines whether or not the “data” input of the switch (as compared to the control input, i.e., the third input) is to be provided by the motion compensator 1670 or the intra prediction module 1660. The output of the switch 1697 is connected in signal communication with a second non-inverting input of the combiner 1619 and with an inverting input of the combiner 1685.

A first input of the frame ordering buffer 1610, an input of the encoder controller 1605 (with extensions to control in-loop direction adaptive de-artifacting filter 1647), and a third input of the in-loop direction-adaptive de-artifacting filter 1647 are available as input of the encoder 1600, for receiving an input picture. Moreover, a second input of the Supplemental Enhancement Information (SEI) inserter 1630 is available as an input of the encoder 1600, for receiving metadata. An output of the output buffer 1635 is available as an output of the encoder 1600, for outputting a bitstream.

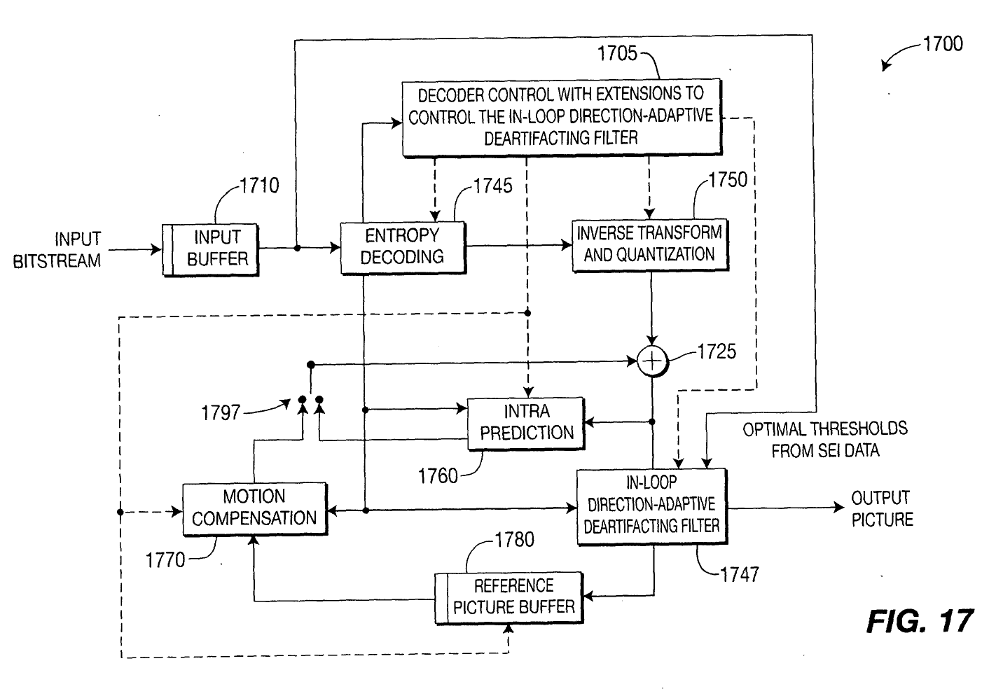

Turning to FIG. 17, another exemplary video decoder capable of performing video decoding in accordance with the MPEG-4 AVC Standard, extended for use with the present principles, is indicated generally by the reference numeral 1700. The extensions applied to video decoder 1700 provide support for in-loop direction-adaptive de-artifact filtering.

The video decoder 1700 includes an input buffer 1710 having an output connected in signal communication with a first input of the entropy decoder 1745 and fourth input of an in-loop direction-adaptive de-artifacting filter 1747. A first output of the entropy decoder 1745 is connected in signal communication with a first input of an inverse transformer and inverse quantizer 1750. An output of the inverse transformer and inverse quantizer 1750 is connected in signal communication with a second non-inverting input of a combiner 1725. An output of the combiner 1725 is connected in signal communication with a second input of the in-loop direction-adaptive de-artifacting filter 1747 and a first input of an intra prediction module 1760. A second output of the in-loop direction-adaptive de-artifacting filter 1747 is connected in signal communication with a first input of a reference picture buffer 1780. An output of the reference picture buffer 1780 is connected in signal communication with a second input of a motion compensator 1770:

A second output of the entropy decoder 1745 is connected in signal communication with a third input of the motion compensator 1770 and a first input of the in-loop direction-adaptive de-artifacting filter 1747. A third output of the entropy decoder 1745 is connected in signal communication with an input of a decoder controller 1705. A first output of the decoder controller 1705 is connected in signal communication with a second input of the entropy decoder 1745. A second output of the decoder controller 1705 is connected in signal communication with a second input of the inverse transformer and inverse quantizer 1750. A third output of the decoder controller 1705 is connected in signal communication with a third input of the in-loop direction-adaptive de-artifacting filter 1747. A fourth output of the decoder controller 1705 is connected in signal communication with a second input of the intra prediction module 1760, with a first input of the motion compensator 1770, and with a second input of the reference picture buffer 1780.

An output of the motion compensator 1770 is connected in signal communication with a first input of a switch 1797. An output of the intra prediction module 1760 is connected in signal communication with a second input of the switch 1797. An output of the switch 1797 is connected in signal communication with a first non-inverting input of the combiner 1725.

An input of the input buffer 1710 is available as an input of the decoder 1700, for receiving an input bitstream. A first output of the in-loop direction-adaptive de-artifacting filter 1747 is available as an output of the decoder 1700, for outputting an output picture.

The encoder controller 805 and the decoder controller 905, relating to FIGS. 8 and 9, respectively, are both modified to obtain the encoder controller 1605 and the decoder controller 1705 with extensions to control the out-loop direction adaptive filter (namely filter 1647 and filter 1747, respectively). This has a consequence on the possible requirement of block level syntax and/or high level syntax for setting, configuring, and adapting the in-loop filter for the most efficient operation. For this purpose several syntax fields may be defined at different levels. TABLE 1 shows exemplary picture parameter set syntax data for out-loop and in-loop direction-adaptive de-artifact filtering, in accordance with an embodiment. TABLE 2 shows exemplary slice header data for out-loop and in-loop direction-adaptive de-artifact filtering, in accordance with an embodiment. Of course, other high level syntax elements may also be used for setting, configuring, and adapting the out-loop filter, while maintaining the spirit of the present principles.

Some of the syntax elements shown in TABLES 1 and 2 will now be described, in accordance with an embodiment.

enable_map_creation_type: is a high level syntax element that can be, for example, either located at the sequence parameter set and/or picture parameter set levels. In an embodiment, a value for this element enables the possibility to change the default value for the type of filtering map.

map_creation_type: specifies the type of filtering map used in in-loop direction-adaptive de-artifact filtering. For example, in an embodiment, it can be used to set the number of classes and boundary sizes of a filtering map.

A description will now be given of some of the many attendant advantages/features of the present invention, some of which have been mentioned above. For example, one advantage/feature is an apparatus having a sparsity-based filter for de-artifact filtering picture data for a picture. The picture data includes different sub-lattice samplings of the picture. Sparsity-based filtering thresholds for the filter are varied temporally.

Another advantage/feature is the apparatus having the sparsity-based filter as described above, wherein the sparsity-based filtering thresholds are varied spatially.

Yet another advantage/feature is the apparatus having the sparsity-based filter as described above, wherein the sparsity based filtering thresholds are varied responsive to at least one of local signal statistics, global signal statistics, local noise, global noise, local distortion, global distortion, compression parameters, prediction modes, a user selection, a video quality measure, and a coding cost measure.

Still another advantage/feature is the apparatus having the sparsity-based filter as described above, where a class map corresponding to a plurality of classes is created and a respective threshold is selected for each of the plurality of classes. Each of the plurality of classes corresponds to a particular set of encoding conditions.

Still yet another advantage/feature is the apparatus having the sparsity-based filter as described above, wherein the sparsity-based filtering thresholds are encoded using at least one of uniform coded values, differentially coded values with respect to previous threshold values, and an average threshold value. The average threshold value is dependent on at least one of at least one coding setting, at least one encoding profile, and at least one quantization parameter. At least one of the uniform coded values and the differential values are encoded using at least one of uniform codes, variable length codes and arithmetic codes.

Moreover, another advantage/feature is the apparatus having the sparsity-based filter as described above, wherein filtering threshold information is transmitted in a coded video bit-stream using at least one high level syntax element.

Further, another advantage/feature is the apparatus having the sparsity-based filter as described above, wherein the filter is configured for at least one of in-loop processing and out-loop processing of the picture data.

Also, another advantage/feature is the apparatus having the sparsity-based filter as described above, wherein the filter is comprised in at least one of a video encoder and a video decoder.

Additionally, another advantage/feature is the apparatus having the sparsity-based filter as described above, wherein the sparsity-based filtering thresholds are selectively applied to an entirety of a picture corresponding to the picture data or a portion thereof.

Moreover, another advantage/feature is the apparatus having the sparsity-based filter wherein the sparsity-based filtering thresholds are selectively applied as described above, wherein the sparsity-based filtering thresholds are independently or jointly adapted.

Further, another advantage/feature is the apparatus having the sparsity-based filter as described above, wherein sparsity-based filtering operations performed by the filter are capable of being at least one of combined, adapted, enabled, and disabled.

Also, another advantage/feature is the apparatus having the sparsity-based filter as described above, wherein the filter is comprised in a video encoder, and whether any of the de-artifacting operations are at least one of combined, adapted, enabled, and disabled is signaled to a corresponding decoder using at least one high level syntax element.

Additionally, another advantage/feature is the apparatus having the sparsity-based filter as described above, wherein the filter is comprised in a video decoder, and whether any of the de-artifacting operations are at least one of combined, adapted, enabled, and disabled is determined from at least one high level syntax element.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
a sparsity-based filter for de-artifact filtering picture data for a picture, the picture data including different sub-lattice samplings of the picture, wherein sparsity-based filtering thresholds for the filter are varied temporally.

2. The apparatus of claim 1, wherein the sparsity-based filtering thresholds are varied spatially.

3. The apparatus of claim 2, wherein the sparsity based filtering thresholds are varied responsive to at least one of local signal statistics, global signal statistics, local noise, global noise, local distortion, global distortion, compression parameters, prediction modes, a user selection, a video quality measure, and a coding cost measure.

4. The apparatus of claim 1, where a class map corresponding to a plurality of classes is created and a respective threshold is selected for each of the plurality of classes, wherein each of the plurality of classes corresponds to a particular set of coding conditions.

5. The apparatus of claim 1, wherein the sparsity-based filtering thresholds are encoded using at least one of uniform coded values, differentially coded values with respect to previous threshold values, and an average threshold value, wherein the average threshold value is dependent on at least one of at least one coding setting, at least one coding profile, and at least one quantization parameter, and wherein at least one of the uniform coded values and the differential values are encoded using at least one of uniform codes, variable length codes and arithmetic codes.

6. The apparatus of claim 1, wherein filtering threshold information is transmitted in a coded video bit-stream using at least one high level syntax element.

7. The apparatus of claim 1, wherein said sparsity-based filter is configured for at least one of in-loop processing and out-loop processing of the picture data.

8. The apparatus of claim 1, wherein said sparsity-based filter is comprised in at least one of a video encoder and a video decoder.

9. The apparatus of claim 1, wherein the sparsity-based filtering thresholds are selectively applied to an entirety of a picture corresponding to the picture data or a portion thereof.

10. The apparatus of claim 9, wherein the sparsity-based filtering thresholds are independently or jointly adapted.

11. The apparatus of claim 1, wherein sparsity-based filtering operations performed by said sparsity-based filter are capable of being at least one of combined, adapted, enabled, and disabled.

12. The apparatus of claim 11, wherein said sparsity-based filter is comprised in a video encoder, and whether any of the de-artifacting operations are at least one of combined, adapted, enabled, and disabled is signaled to a corresponding decoder using at least one high level syntax element.

13. The apparatus of claim 11, wherein said sparsity-based filter is comprised in a video decoder, and whether any of the de-artifacting operations are at least one of combined, adapted, enabled, and disabled is determined from at least one high level syntax element.

14. A method, comprising:
de-artifact filtering picture data for a picture, the picture data including different sub-lattice samplings of the picture, wherein sparsity-based filtering thresholds for the filtering are varied temporally.

15. The method of claim 14, wherein the sparsity-based filtering thresholds are varied spatially.

16. The method of claim 15, wherein the sparsity based filtering thresholds are varied responsive to at least one of local signal statistics, global signal statistics, local noise, global noise, local distortion, global distortion, compression parameters, prediction modes, a user selection, a video quality measure, and a coding cost measure.

17. The method of claim 14, further comprising:
creating a class map corresponding to a plurality of classes; and
selecting a respective threshold for each of the plurality of classes, wherein each of the plurality of classes corresponds to a particular set of encoding conditions.

18. The method of claim 14, further comprising encoding the sparsity-based filtering thresholds using at least one of uniform coded values, differentially coded values with respect to previous threshold values, and an average threshold value, wherein the average threshold value is dependent on at least one of at least one coding setting, at least one encoding profile, and at least one quantization parameter, and wherein at least one of the uniform coded values and the differential values are encoded using at least one of uniform codes, variable length codes and arithmetic codes.

19. The method of claim 14, further comprising transmitting filtering threshold information in a coded video bit-stream using at least one high level syntax element.

20. The method of claim 14, further comprising configuring the sparsity-based filtering for at least one of in-loop processing and out-loop processing of the picture data.

21. The method of claim 14, wherein the sparsity-based filtering is performed in at least one of a video encoder and a video decoder.

22. The method of claim 14, wherein the sparsity-based filtering thresholds are selectively applied to an entirety of a picture corresponding to the picture data or a portion thereof.

23. The method of claim 22, wherein the sparsity-based filtering thresholds are independently or jointly adapted.

24. The method of claim 14, wherein said sparsity-based filtering step comprises applying at least one sparsity-based filtering operation to the picture data, wherein the at least one sparsity-based filtering operation is capable of being at least one of combined, adapted, enabled, and disabled.

25. The method of claim 24, wherein the sparsity-based filtering is performed in a video encoder, and the method further comprises signaling, to a corresponding decoder, whether any of the de-artifacting operations are at least one of combined, adapted, enabled, and disabled using at least one high level syntax element.

26. The method of claim 24, wherein the sparsity-based filtering is performed in a video decoder, and the method further comprises determining whether any of the de-artifacting operations are at least one of combined, adapted, enabled, and disabled from at least one high level syntax element.
